(19) United States
(12) Patent Application Publication
(10) Pub. No.: US 2026/0276432 A1
(43) Pub. Date: Sep. 17, 2026

(54) VOLUMETRIC DOSING SYSTEM

(71) Applicant: nVenia LLC, Wood Dale, IL (US)

(72) Inventors: Christopher Reinert, Warrenville, IL (US); Behzad Jafari, Bartlett, IL (US)

(21) Appl. No.: 19/566,534

(22) Filed: Mar. 13, 2026

Related U.S. Application Data
(60) Provisional application No. 63/771,457, filed on Mar. 13, 2025.

(51) Int. Cl. G01G 15/00; G01F 11/20

(52) U.S. Cl. CPC G01G 15/001; G01F 11/20

(57) ABSTRACT

A volumetric dosing system includes a base, and a volumetric distribution assembly supported on the base and including a motor, a first side wall, a second side wall coupled to the motor, the second side wall movable relative to the first side wall, and a cavity defined by a volume between first side wall and the second side wall. Relative movement between the first side wall and the second side wall changes the volume of the cavity. The volumetric dosing system further includes a weight sensor in communication with the volumetric distribution assembly and configured to produce a weight signal, a user interface coupled to the volumetric distribution assembly and operable to produce a signal corresponding with a weight setpoint, and an electronic controller communicatively coupled to the weight sensor.

### CROSS-REFERENCE TO RELATED APPLICATIONS

This application claims priority to U.S. Provisional Patent Application No. 63/771,457, filed on Mar. 13, 2025, the entire contents of which are incorporated by reference herein.

### FIELD

Exemplary embodiments relate to the art of volumetric dosing, and more particularly, to control of an industrial volumetric dosing system.

### BACKGROUND

Volumetric dosing systems are configured to distribute a specific volume of a material from an input. One example of a volumetric dosing system is a drum system with one or more drums and a plurality of fins that define a plurality of compartments with set volume for a material to fill. As the drums rotate, material fills the volume of the compartments and is then deposited downstream of the dosing system. As the volume of the compartment is finite, the amount of deposited material can be accurately estimated. In some drum systems, size of the compartments and the corresponding dosing volume is variable. One way to vary the compartment size is to have adjustable drums or fins. However, it is often complex and time consuming to manually adjust the relative positions of the fins and volume of the compartments. Additionally, manually adjusting the size of the compartments may also necessitate stopping the volumetric dosing system.

### SUMMARY

In one aspect of the invention, a volumetric dosing system includes a base and a volumetric distribution assembly supported on the base. The volumetric distribution assembly includes a motor, a first side wall, a second side wall coupled to the motor, the second side wall movable relative to the first side wall, and a cavity defined by a volume between first side wall and the second side wall, wherein relative movement between the first side wall and the second side wall changes the volume of the cavity. A weight sensor is in communication with the volumetric distribution assembly and is configured to produce a weight signal. A user interface is coupled to the volumetric distribution assembly, the user interface operable to produce a signal corresponding with a weight setpoint. Further, an electronic controller is communicatively coupled to the weight sensor. The electronic controller is configured to calculate a weight error based on a difference between a weight signal received from the weight sensor and a weight setpoint received from the user interface, calculate a volume adjustment signal corresponding with the weight error, and drive the motor using the volume adjustment signal to move the second side wall relative to the first side wall.

In another aspect of the invention, a method for controlling a volumetric dosing system includes providing a volumetric distribution assembly including an actuator and a volume defined by the actuator, calculating a weight error based on a difference between a weight signal received from a weight sensor and a weight setpoint received from a user interface, calculating a volume adjustment signal corresponding with the weight error, and driving the actuator using the volume adjustment signal to adjust the volume.

In yet another aspect of the invention, a volumetric dosing system including a base, a volumetric distribution assembly supported on the base, the volumetric distribution assembly including a motor, a first wall member, a second wall member coupled to the motor, the second wall member movable relative to the first wall member, and a cavity defined by a volume between first wall member and the second wall member, wherein relative movement between the first wall member and the second wall member changes the volume of the cavity, and a controller configured to drive the motor to move the second wall member relative to the first wall member.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some constructions, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

### BRIEF DESCRIPTION OF THE DRAWINGS

FIG. 1A is a front perspective view of a volumetric dosing assembly.

FIG. 1B is a rear perspective view of the volumetric dosing assembly of FIG. 1A.

FIG. 2 is a side view of the volumetric dosing assembly of FIG. 1A

FIG. 3 is a cross-sectional view of portion 3-3 of the volumetric dosing assembly of FIG. 2.

FIG. 4 is a cross-sectional view of portion 4-4 of the volumetric dosing assembly of FIG. 1A without the hopper.

FIG. 5 is a bottom view of the volumetric dosing assembly of FIG. 1A.

FIG. 6 is a cross-sectional view of portion 6-6 of the volumetric dosing assembly of FIG. 2.

FIG. 7 is a cross-sectional view of portion 7-7 of the volumetric dosing assembly of FIG. 2 illustrating a phase shifting mechanism.

FIG. 8 is an exemplary schematic of a control system for the volumetric dosing assembly of FIG. 1A.

FIG. 9 is an exemplary schematic of a system including the volumetric dosing assembly of FIG. 1A and a check weigher.

FIG. 10 is an exemplary control scheme for the volumetric dosing assembly of FIG. 1A.

FIG. 11 is a flowchart illustrating an exemplary control method for the volumetric dosing assembly of FIG. 1A.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Reference may be made herein to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower”, or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

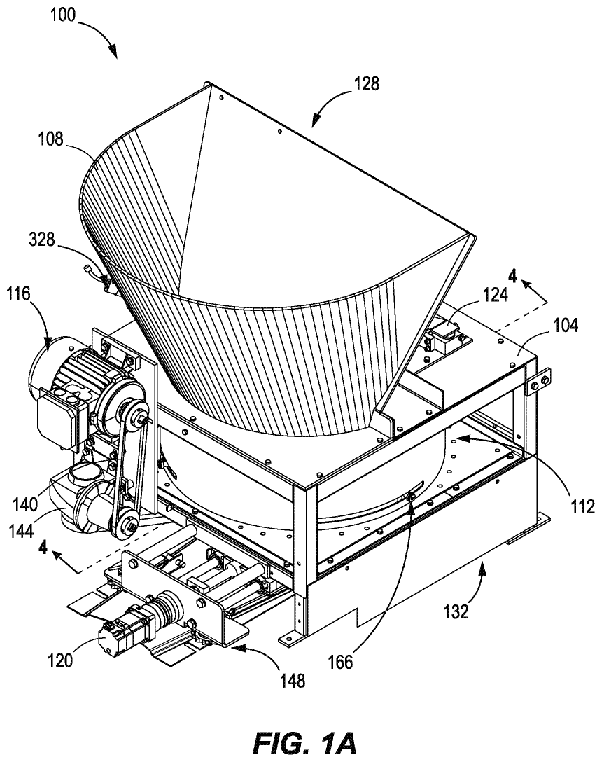

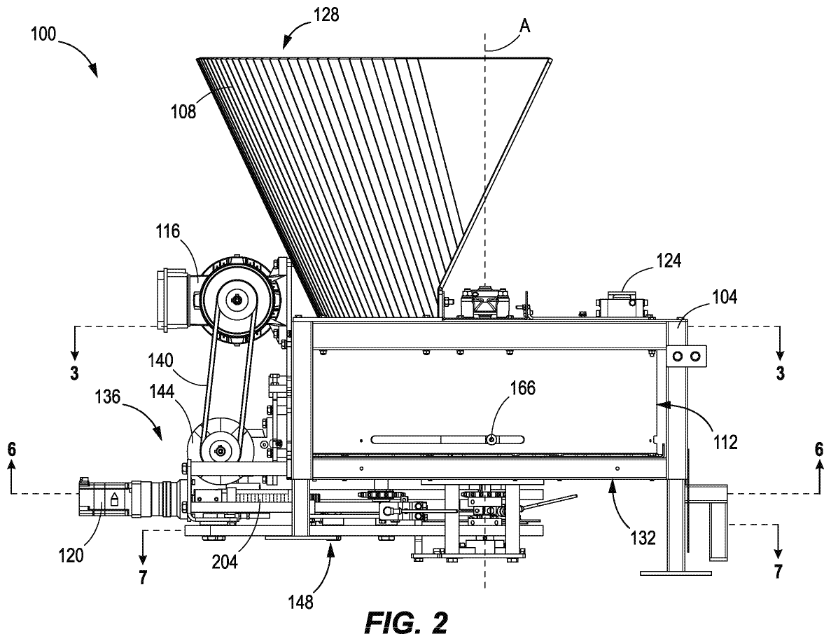

Referring now to the figures, FIGS. 1A-7 illustrate a volumetric dosing system 100. The volumetric dosing system 100 includes a base 104, a hopper 108 supported on the base 104, and a drum assembly 112 in communication with the hopper 108 and rotatably supported on the base 104. The base 104 further supports a drive motor 116, or other actuator, rotatably coupled to the drum assembly 112 and a servo 120. The illustrated embodiment further includes a slapper 124 disposed on the base 104 and in communication with the drum assembly 112. With specific reference to FIGS. 1A and 1B, the hopper 108 defines an inlet 128 for receiving a material (e.g., ice, grain, fruit, etc.) and is positioned such that material flows from the hopper 108 to the drum assembly 112. The drum assembly 112 and the base 104 cooperate (FIG. 3) to define an outlet 132 for material to exit the drum assembly 112. It will be appreciated that the systems and methods disclosed below may apply for a variety of volumetric distribution assemblies in addition to a drum assembly.

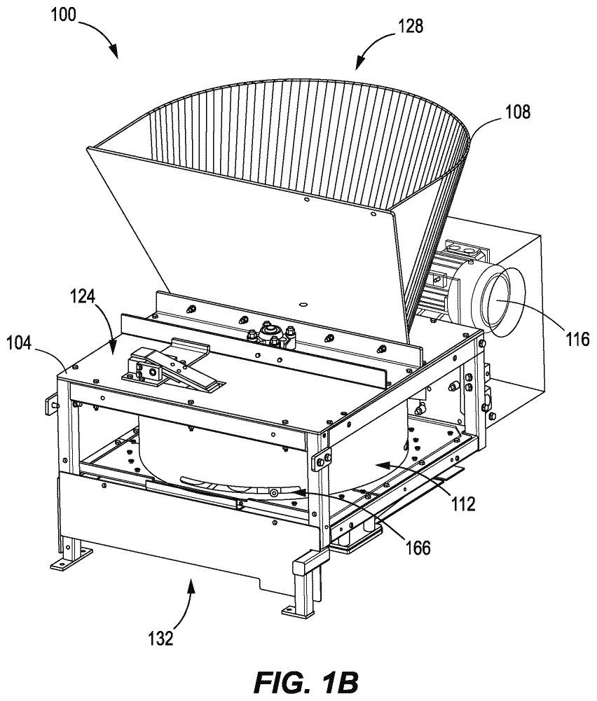

With specific reference to FIG. 2, the drive motor 116 rotates the drum assembly 112 about a rotational axis A using a transmission 136. The transmission 136 is supported on the base 104 and includes a belt 140 coupled to the drive motor 116, a gearbox 144 coupled to the belt 140 such that the belt 140 transfers torque from the drive motor 116 to the gearbox 144. In the illustrated embodiment, the belt 140 is a V-belt. In other embodiments, the belt 140 may be another type of transmission belt such as a timing belt. It will be appreciated that the belt 140 may regulate the torque transferred between the drive motor 116 and the gearbox 144 by slipping in response to a high torque. The gearbox 144 is additionally coupled to a phase shifting mechanism 148, which as described in further detail below, that drives the rotation of the drum assembly 112. The phase shifting mechanism 148 drives the rotation of the entire drum assembly 112 and can be controlled to adjust the volume received and subsequently output by the drum assembly 112. During operation, a material deposited into the hopper 108 is subsequently deposited into the drum assembly 112. As the drum assembly 112 rotates, the slapper 124 may serve to normalize the volume of material within cavities of the drum assembly 112. In some embodiments, the slapper 124 may remove or offset a portion of the material disposed within the drum assembly 112 at or above a certain height to maintain a regular material height within the drum assembly 112 before the material is output through the outlet 132.

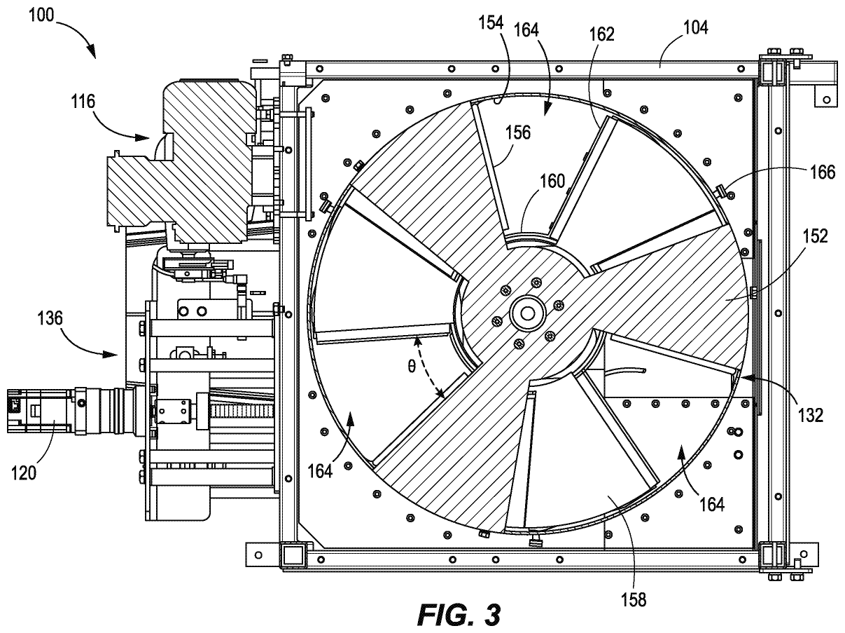

With reference to FIGS. 3 and 4, the drum assembly 112 further includes an outer drum 152 and an inner drum 158 disposed within the outer drum 152. The outer drum 152 includes an outer wall 154 and first side walls 156, or first wall members, and the inner drum 158 includes an inner wall 160 and second side walls 162, or second wall members. The inner drum 158 and the outer drum 152 cooperate to form a plurality of wedge-shaped cavities 164 for receiving and distributing the material from the hopper 108. Specifically, the cavities 164 are each defined by the perimeter formed by respective portions of the outer wall 154 and the inner wall 160 as well as the respective first side wall 156 and respective second side wall 162. The cavities 164 further define an angle ⊖ corresponding with angular distance between the first side wall 156 and the second side wall 162. The angle ⊖, the radius of the outer wall 154, the radius of the inner wall 160, and the height of the drum assembly 112 may be used to determine a volume of each of the cavities 164. Accordingly, the drum assembly 112 may receive a predetermined volume of material from the hopper 108 using each of the cavities 164. In some embodiments, the hopper 108 is filled to a minimum height sensed by a sensor 328 that protrudes into the side of the hopper 108 (See FIG. 1A). Under the force of gravity, the material is pushed from the hopper 108 into at least one of the cavities 164. Each cavity may then subsequently output a specific volume of material to the outlet 132 at a timing corresponding with the rotational velocity of the drums.

As the radius of the outer wall 154, the radius of the inner wall 160, and the height of the drum assembly 112 are constant, the angle ⊖ alone may be used to determine the volume of the cavities 164. In the illustrated embodiment, the outer drum 152 and the inner drum 158 are rotatable relative to the base 104 and each other to adjust the angle ⊖ and thereby the volume of the cavities 164. In other words, adjustment of the angle ⊖ correspondingly adjusts the volume of each of the cavities 164. In some embodiments, the drum assembly 112 may include a pin 166 for securing the outer drum 152 to the inner drum 158. Additionally, in some embodiments, the pin 166 may be fastened to the inner drum 158 such that an operator may rotate the inner drum 158 relative to the outer drum 152 using the pin 166. As discussed in further detail below, in the illustrated embodiment, the pin 166 does not secure the outer drum 152 to the inner drum 158. Instead, in the illustrated embodiment, the phase shifting mechanism 148 is configured to drive the rotation of both the outer drum 152 and the inner drum 158 and control the angle ⊖, and accordingly the volume of the cavities 164.

Returning reference to the phase shifting mechanism 148 as illustrated in FIG. 4, the phase shifting mechanism 148 includes a compound gear train having a central shaft 168 rotatable about the axis A. The central shaft 168 is coupled to the outer drum housing 152 such that the rotation of the central shaft 168 induced by the phase shifting mechanism 148 causes the outer drum housing 152 to correspondingly rotate. The central shaft 168 is partially nested within a sleeve portion 172 of the inner drum housing 158 and coupled to the outer drum housing 152 through a flange 176. In the illustrated embodiment, the central shaft 168 is coupled to the flange 176 using a shaft clamp device including at least one set screw configured to tighten the shaft clamp device to the central shaft 168. The flange 176 is coupled to the outer drum housing 152 using a plurality of fasteners. In other embodiments, other fastening means (e.g., keyed couplings, friction fits, adhesives etc.) may be incorporated. The central shaft 168 is additionally rotatably supported by a plurality of bearings 178 coupled to the base 104. It will be appreciated that the central shaft 168 and the sleeve portion 172 of the inner drum housing 158 are not fixed together.

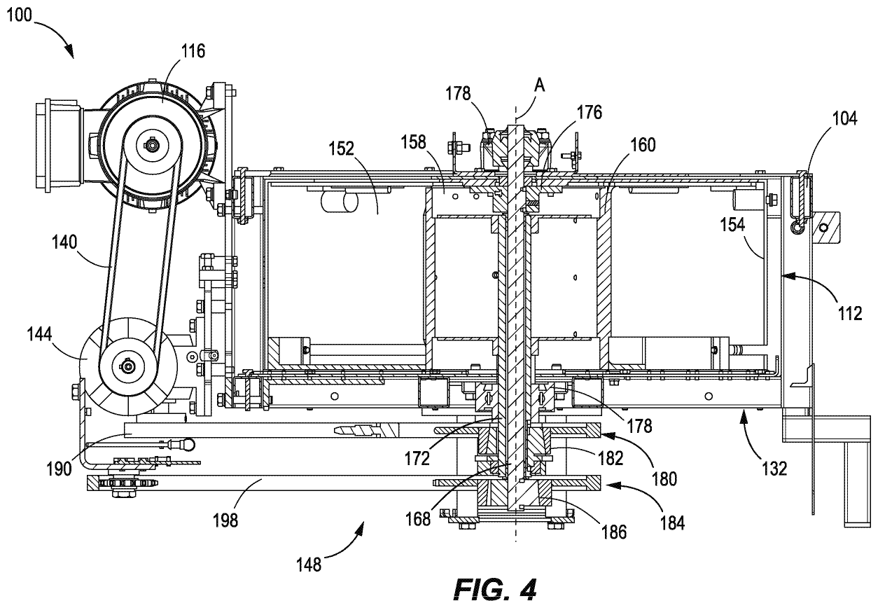

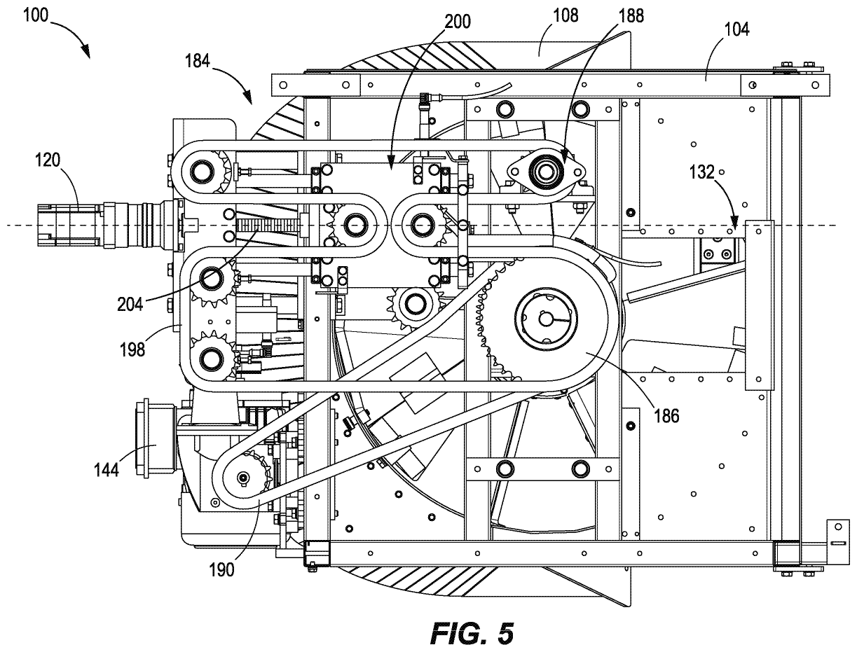

With continued reference to FIG. 4 and additional reference to FIGS. 5 and 6, the phase shifting mechanism 148 further includes a first gear train 180 having a sleeve gear 182 coupled to the sleeve portion 172 of the inner drum housing 158, a second gear train 184 having a shaft gear 186 coupled to the central shaft 168, and an idler driveshaft 188. The first gear train 180 is directly coupled to the transmission 136 and thereby transfers the output of the drive motor 116 to the inner drum housing 158. The second gear train 184 is coupled to the first gear train 180 through the idler driveshaft 188. The second gear train 184 is configured to induce a phase change between the central shaft 168 and the sleeve portion 172, thereby controlling the angle ⊖. Using two connected gear trains, the phase shifting mechanism 148 may simultaneously drive the outer drum housing 152 using the first gear train 180 and the inner drum housing 158 using the second gear train 184. By having two connected gear trains, the phase shifting mechanism 148 allows for independent control of the phase shift between the sleeve portion 172 and the central shaft 168 and the operating speed of the transmission 136. In the illustrated embodiment, the sleeve gear 182 and the shaft gear 186 are coupled to the respective sleeve portion 172 and central shaft 168 by a keyed coupling. In other embodiments, other fastening means may additionally or alternatively be incorporated. The first gear train additionally includes a first chain 190 coupled to the gearbox 144. Accordingly, the drive motor 116 provides torque to the gearbox 144 through the belt 140, and the torque is then provided from the gearbox 144 through the first chain 190 to rotate the sleeve portion 172 of the inner housing 158 via the sleeve gear 182. As best shown in FIG. 6, the first gear train 180 additionally includes a tensioning gear 194 in contact with the first chain 190. The first chain 190 is further coupled to the idler gear driveshaft 188, which further transfers the torque of the drive motor 116 to the second gear train 184.

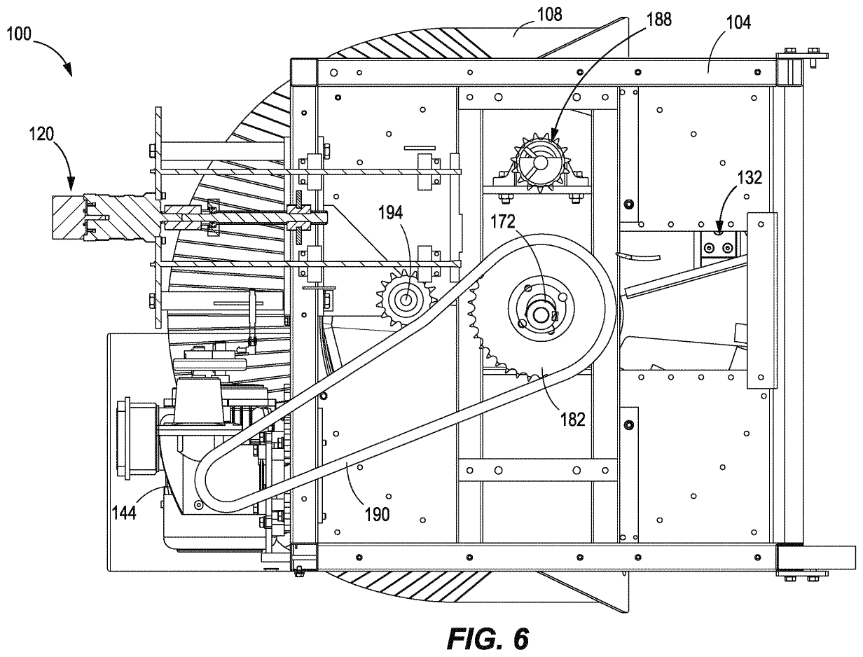

With specific reference to FIGS. 5 and 7, the second gear train 184 is a differential gear mechanism configured to induce a phase shift in the shaft gear 186 while maintaining the drive speed output by the drive motor 116. The second gear train 184 includes a second chain 198 coupled to a carrier 200. The carrier 200 is coupled to a leadscrew 204 driven by the servo 120. The leadscrew 204 translates the carrier 200 along a track 208. Broadly, the translation of the carrier 200 induces a rotation, or phase advance, into the shaft gear 186 relative to the sleeve gear 182. More particularly, the phase shift may be equal to the translation of the carrier 200 multiplied by 2 and divided by the radius of the shaft gear 186, as exemplified in the below equation.

$$φ = 2 Δ x / R \qquad 1 )$$

It will be appreciated a leadscrew 204 driven by a servo 120 provides very precise and granular control of the translation of the carrier 200. Accordingly, the leadscrew 204 and servo 120 allow for precise control of the phase shift between the inner drum housing 158 and the outer drum housing 152.

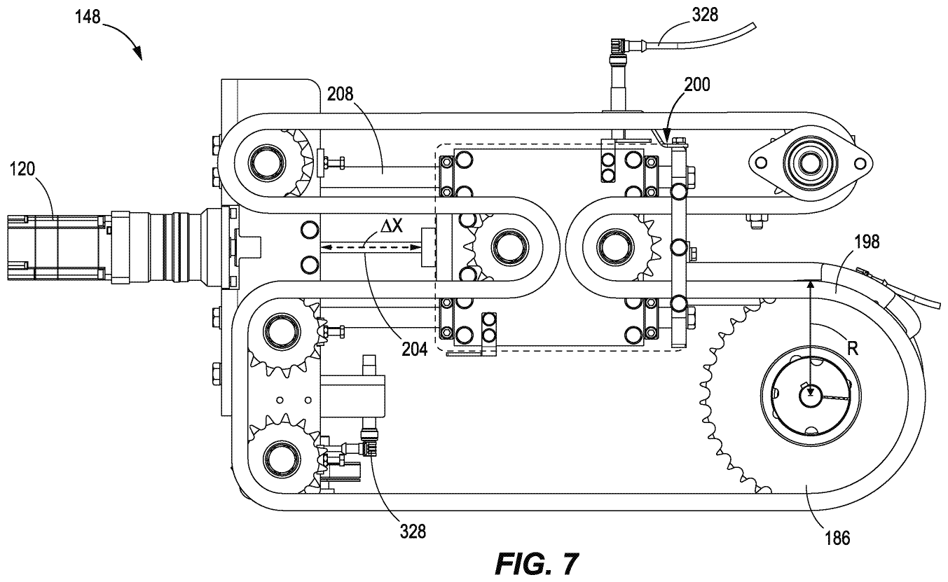

FIG. 8 illustrates an exemplary schematic diagram of the electronic control system 300 for the volumetric dosing system 100. The electronic processor 304 includes combinations of hardware and software that are operable to, among other things, control and monitor the operation of the volumetric dosing system 100. The electronic processor is electrically and/or communicatively connected to a motor driver 308 and a servo driver 312 configured to control the operation of the drive motor 116 and the servo 120, respectively. The electronic processor 304 is also connected to a control panel 316 having a user interface, one or more position sensors 320, a weight sensor 324, and other sensors 328 (e.g., ultrasonic sensors, temperature sensors, etc.) used to monitor the volumetric dosing system 100. The electronic processor 304 is powered by an energy source 332 such as a battery or an AC outlet (e.g., a 24V outlet). The electronic processor 304 may be a microprocessor, a microcontroller, or another suitable programmable device. The electronic processor 304 may include a memory 336 and a control unit 340. The memory 336 is a non-transitory computer readable medium and includes, for example, a program storage area and a data storage area. The control unit 340 is configured to retrieve from the memory 336 and execute, among other things, software or instructions related to the control processes and methods described herein. In other constructions, the electronic processor 304 may include additional, fewer, or different components.

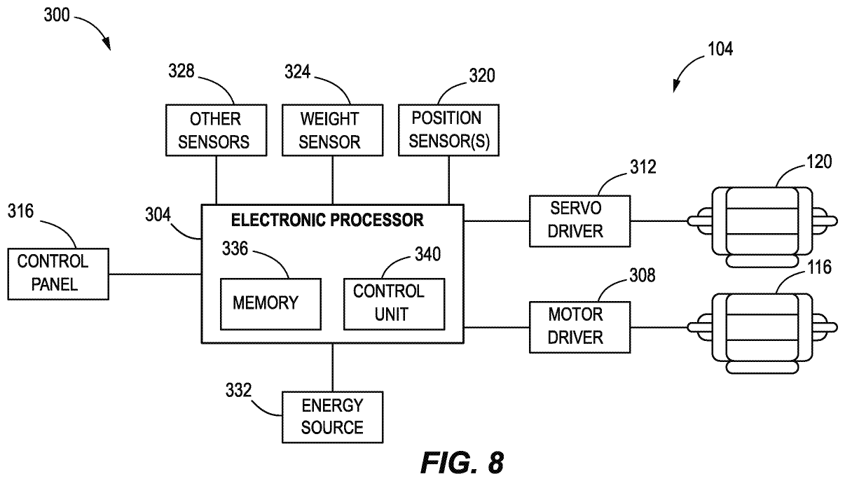

Using the servo driver 312, the electronic processor 304 may adjust the position of the carrier 200 to adjust the relative phase delay between the inner drum housing 158 and the outer drum housing 152, thereby adjusting the volume of the cavities 164. The electronic processor 304 may additionally monitor the angle ⊖ between the inner drum housing 158 and the outer drum housing 152 using the one or more position sensors 320. The electronic processor 304 may communicate with the control panel 316 to receive a plurality of operational parameters including a weight setpoint, a target speed, a runtime, etc. For example, the user interface of the control panel 316 may allow for an operator to set a desired volume. Based on the input volume, received through the control panel 316, the electronic processor 304 may calculate a current volume using the one or more position sensors 320, calculate an adjustment angle based on a difference between the input volume and a calculated volume, and control the servo driver 312 to actuate the servo 120 according to the adjustment angle. The servo 120 may then adjust the carrier 200, which induces a phase shift between the inner drum housing 158 and the outer drum housing 152 using the phase shifting mechanism 148. FIG. 9 illustrates an exemplary embodiment where the volumetric dosing system 100 outputs to a storage container (e.g., a pallet, a crate, a bag etc.), which is then passed over a check weigher (or another weight sensor 324).

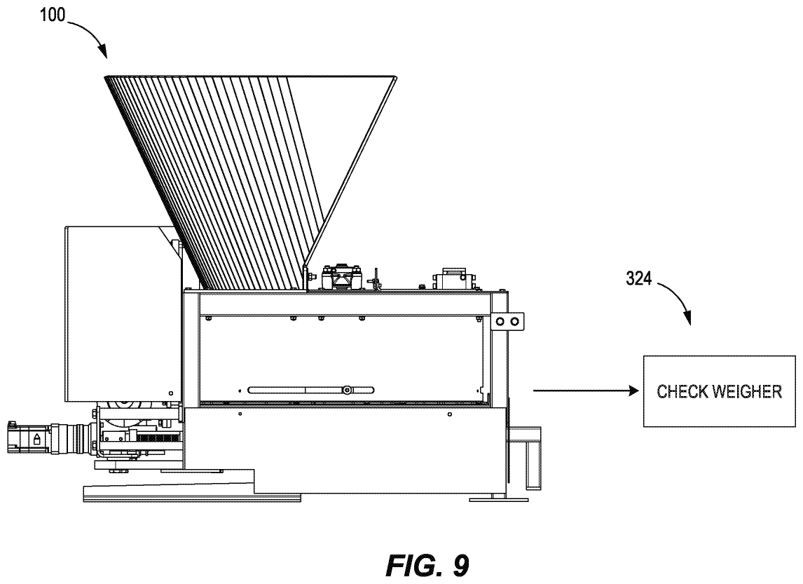

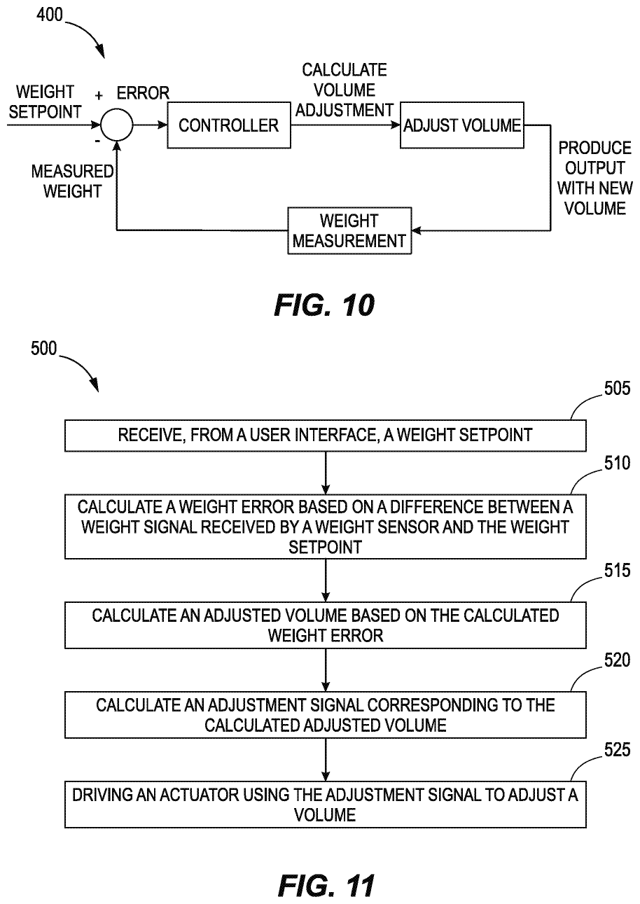

FIGS. 10 and 11 illustrate an exemplary closed loop algorithm for the control of the volumetric dosing system 100 illustrated in FIG. 9. At step 505, the electronic processor 304 receives a weight setpoint. The weight setpoint may be received from a user interface (e.g., through the control panel 316), retrieved from memory, generated by a computer program, received from another system, or otherwise determined automatically. At step 510, the electronic processor receives a weight measurement from a weight sensor and calculates a weight error based on the difference between the weight measurement and the weight setpoint. At step 515, the electronic processor 304 calculates an adjusted volume based on the weight error. For example, the electronic processor 304 may utilize a PID algorithm to calculate the adjusted volume based on the error. In another example, if the material and average density of the material is known, the electronic processor 304 may directly calculate the volume change required to achieve the weight setpoint. At step 520, the electronic processor 304 calculates an adjustment signal corresponding to the previously calculated adjusted volume. For example, based on a calculated volumetric change requirement, the electronic processor 304 may calculate a corresponding angular shift between the inner drum housing 158 and the outer drum housing 152. The electronic processor 304 may then further calculate the required translation of the carrier 200 required to induce a phase delay corresponding with the determined angular shift. At step 525, the electronic processor 304 drives an actuator using the adjustment signal to adjust the volume output by the volumetric dosing system 100. For example, the electronic processor 304 may communicate with the servo driver 312 using the adjustment signal to drive the leadscrew 204, causing the carrier 200 to translate. As the carrier translates, a phase delay is induced between the inner drum housing 158 and the outer drum housing 152, causing the relative angle ⊖ between the inner drum housing 158 and the outer drum housing 152 to change, and thereby causing the volume defined by the cavity 164 to adjust.

Various disclosures are set forth in the following claims.

What is claimed is:

1. A volumetric dosing system comprising:
a base;
a volumetric distribution assembly supported on the base, the volumetric distribution assembly including
a motor,
a first side wall,
a second side wall coupled to the motor, the second side wall movable relative to the first side wall, and
a cavity defined by a volume between first side wall and the second side wall, wherein relative movement between the first side wall and the second side wall changes the volume of the cavity;
a weight sensor in communication with the volumetric distribution assembly, the weight sensor configured to produce a weight signal;
a user interface coupled to the volumetric distribution assembly, the user interface operable to produce a signal corresponding with a weight setpoint; and
an electronic controller communicatively coupled to the weight sensor, the electronic controller configured to:
calculate a weight error based on a difference between a weight signal received from the weight sensor and a weight setpoint received from the user interface,
calculate a volume adjustment signal corresponding with the weight error, and
drive the motor using the volume adjustment signal to move the second side wall relative to the first side wall.

2. The volumetric dosing system of claim 1, wherein the volumetric distribution assembly includes an inner drum and an outer drum, and wherein the first side wall is coupled to one of the inner drum and the outer drum, and the second side wall is coupled to the other of the inner drum and the outer drum.

3. The volumetric dosing system of claim 2, wherein relative rotation between the inner drum and the outer drum changes an angular distance between the first side wall and the second side wall, thereby changing the volume of the cavity.

4. The volumetric dosing system of claim 1, wherein the motor drives a phase shifting mechanism configured to adjust a relative rotational phase between the first side wall and the second side wall.

5. The volumetric dosing system of claim 1, further comprising a position sensor configured to detect a relative position between the first side wall and the second side wall, wherein the electronic controller is configured to calculate a current volume based on the relative position.

6. The volumetric dosing system of claim 1, further comprising a hopper supported on the base and configured to supply material to the cavity.

7. The volumetric dosing system of claim 1, further comprising a slapper positioned adjacent to the volumetric distribution assembly and configured to normalize a volume of material within the cavity prior to dispensing.

8. A method for controlling a volumetric dosing system, the method comprising:
providing a volumetric distribution assembly including an actuator and a volume defined by the actuator;
calculating a weight error based on a difference between a weight signal received from a weight sensor and a weight setpoint received from a user interface;
calculating a volume adjustment signal corresponding with the weight error; and
driving the actuator using the volume adjustment signal to adjust the volume.

9. The method of claim 8, wherein calculating the volume adjustment signal includes calculating a volume change required to achieve the weight setpoint.

10. The method of claim 8, wherein driving the actuator includes communicating the volume adjustment signal to a servo driver.

11. The method of claim 8, further comprising providing a volumetric distribution assembly including a motor, an outer drum having a first side wall, an inner drum disposed within the outer drum and having a second side wall, and a cavity defined by a volume between the first side wall and the second side wall.

12. The method of claim 11, wherein calculating the volume adjustment signal includes calculating a corresponding angular shift between the inner drum and the outer drum.

13. The method of claim 12, further comprising calculating a required translation of a carrier to induce a phase delay corresponding with the angular shift.

14. The method of claim 11, wherein driving the actuator causes a carrier to translate, thereby inducing a phase delay between the inner drum and the outer drum.

15. The method of claim 11, wherein adjusting the volume includes changing a relative angle between the inner drum and the outer drum to adjust the volume.

16. A volumetric dosing system comprising:
a base;
a volumetric distribution assembly supported on the base, the volumetric distribution assembly including
a motor,
a first wall member,
a second wall member coupled to the motor, the second wall member movable relative to the first wall member, and
a cavity defined by a volume between first wall member and the second wall member, wherein relative movement between the first wall member and the second wall member changes the volume of the cavity; and
a controller configured to drive the motor to move the second wall member relative to the first wall member.

17. The volumetric dosing system of claim 16, further comprising a sensor in communication with the volumetric distribution assembly, the sensor configured to produce a weight signal, wherein the controller is configured to drive the motor using the weight signal.

18. The volumetric dosing system of claim 16, wherein the volumetric distribution assembly includes an inner drum and an outer drum, and wherein the first wall member is coupled to one of the inner drum and the outer drum, and the second wall member is coupled to the other of the inner drum and the outer drum.

19. The volumetric dosing system of claim 18, wherein relative rotation between the inner drum and the outer drum changes an angular distance between the first wall member and the second wall member, thereby changing the volume of the cavity.

20. The volumetric dosing system of claim 18, wherein the motor is configured to rotate the inner drum and the outer drum about a rotational axis.
